(19) United States
(12) Patent Application Publication
(10) Pub. No.: US 2025/0131502 A1
(43) Pub. Date: Apr. 24, 2025

(54) OPTIMIZATION METHOD AND SYSTEM FOR ASSET ALLOCATION

(71) Applicants: QINGHAI GAO, KUNSHAN (CN); HAORAN GAO, KUNSHAN (CN)

(72) Inventors: QINGHAI GAO, KUNSHAN (CN); HAORAN GAO, KUNSHAN (CN)

(21) Appl. No.: 18/490,885

(22) Filed: Oct. 20, 2023

(51) Int. Cl. G06Q 40/06

(52) U.S. Cl. CPC G06Q 40/06

(57) ABSTRACT

The present invention discloses an asset allocation method and system. The method comprises acquiring the returns of each asset and determining the annual return rate and the annual volatility of each asset; determining expected returns according to the annual return rate, determining expected volatility according to the annual volatility, and constructing an efficient frontier by taking the expected returns as a horizontal coordinate and the expected volatility as a vertical coordinate; acquiring the Sharpe ratio and the Sharpe return rate of each point within the efficient frontier, and determining the optimal asset allocation according to the weight of each required asset corresponding to the Sharpe ratio and the Sharpe return rate.

### TECHNICAL FIELD

The present invention relates to the technical field of asset allocation, in particular to an optimization method and system for asset allocation.

### BACKGROUND

At present, the common method of asset allocation is the Markowitz model. The Markowitz model brings the broad asset allocation into the era of quantitative allocation. The Markowitz model has groundbreaking significance in theory, but also encounters many problems in practice. For example, users are not familiar with the relevant mathematical knowledge, cannot calculate the covariance between securities, and cannot accurately calculate the expected return rate. Therefore, the allocation shall be optimized.

At present, the methods used to optimize the asset allocation include:
1) The data is processed by a linear programming function provided by Excel tool; and the results are trustable, but the workload of manual operation is relatively large;
2) An index of a single variety or a combination is calculated by historical data based on fundamentals or predicted data, but the above index often does not consider the volatility and risk-free return of the assets;
3) A quantitative investment system is established according to the index, but the index is easy to be used by those who illegally manipulate stock price or amplified by trend speculators, thereby increasing the volatility of the overall market and causing great damage to value investors and broad medium and small investors;
4) Professional software is designed based on complex software design language such as C language, but high development cost and usage fee make ordinary medium and small investors unaffordable;

Therefore, the problem to be solved by those skilled in the art is how to propose an optimization method for asset allocation to overcome the shortcomings and deficiencies of the current optimization method for asset allocation.

### SUMMARY

In view of the above defects, the present invention provides an optimization method and system for asset allocation based on Sharpe ratio. In order to achieve the above purpose, the present invention adopts the following technical solution:

On the one hand, the present invention discloses an asset allocation method, which comprises:
acquiring the returns of each asset and determining the annual return rate and the annual volatility of each asset;
determining expected returns according to the annual return rate, determining expected volatility according to the annual volatility, and constructing an efficient frontier by taking the expected returns as a horizontal coordinate and the expected volatility as a vertical coordinate;
acquiring the Sharpe ratio and the Sharpe return rate of each point within the efficient frontier, and determining the optimal asset allocation according to the weight of each required asset corresponding to the Sharpe ratio and the Sharpe return rate.

Preferably, the annual return rate is obtained by the following formula:

$${r}_{j} = {r}_{day} * 243$$

wherein rⱼ represents the return rate of the j^{th} asset; and r_{day} is the average j^{th} asset, expressed as: return rate of the

$${r}_{day} = 1 / n * {\sum }_{i = 1}^{n} {r}_{i}$$

wherein rᵢ is the return of the i^{th} period, and n represents the total number of periods;
The annual volatility is obtained by the following formula:

$${σ}_{j} = {σ}_{day} * 243$$

wherein σ_{day} is the average volatility of the j^{th} asset, and the expression is:

$${σ}_{day} = \sqrt{( 1 / n - 1 ) * {\sum }_{i = 1}^{n} ( {r}_{day} - {\overline{r}}_{i} )} .$$

r̅ᵢ represents the average return value of the previous i periods.

Preferably, according to the annual return rate, the expected return is obtained by the following formula:

$${r}_{p} = {\sum }_{j = 1}^{m} {ω}_{j} {r}_{j} ,$$

$$wherein$$

$${\sum }_{j = 1}^{m} {ω}_{j} = 1$$

$$E ( {r}_{p} ) = {\sum }_{j = 1}^{m} {ω}_{j} E ( {r}_{j} )$$

wherein ωⱼ is the weight of each asset and E(rₚ) is the expected return.

Preferably, according to the annual volatility, the expected volatility is obtained by the following formula:

$${σ}_{p} = \sqrt{W \sum {W}^{T}} ,$$

$$wherein \sum is$$

$$\sum = [ \begin{matrix}{σ}_{1}^{2} & {σ}_{12} & … & {σ}_{1 n} \\ {σ}_{21}^{} & {σ}_{2}^{2} & … & {σ}_{2 n} \\ ⋮ & ⋮ & ⋱ & ⋮ \\ {σ}_{N 1} & {σ}_{N 2} & … & {σ}_{N}^{2}\end{matrix} ]$$

wherein W is a matrix of ωᵢ, W^{T} is a transpose matrix, n is a sequence of securities, and Nis nn, i.e., a matrix series of securities.

Preferably, the Sharpe ratio is:

$$S = E ( {r}_{p} ) / {σ}_{p}$$

wherein E(rₚ) is the expected return, and σₚ is the expected volatility;
The expression of the Sharpe return rate is:

$${\overline{r}}_{p} = {\sum }_{i = 1}^{n} {ω}_{i} E ( {r}_{p} )$$

Preferably, the acquired returns of each asset are aligned and checked.

On the other hand, the present invention further discloses an asset allocation system, which comprises:
a data processing module for determining the annual return rate and the annual volatility of each asset according to the returns of each asset;
a frontier constructing module for constructing an efficient frontier, comprising determining the horizontal coordinate of the efficient frontier according to the annual return rate and determining the vertical coordinate of the efficient frontier according to the annual volatility;
an asset allocation module for acquiring the Sharpe ratio and the Sharpe return rate of each point within the efficient frontier, and outputting the corresponding weight of each asset when the Sharpe ratio and the Sharpe return rate are maximum.

Preferably, the asset allocation system further comprises a data preprocessing module for acquiring the returns of each asset, aligning, checking and then storing the returns for invocation by the data processing module.

Preferably, the asset allocation system further comprises a display module for visually displaying the efficient frontier and the determined weight ratio of each asset.

Preferably, the display module is also used for displaying the corresponding expected return rate, expected volatility and the corresponding Sharpe ratio of the determined weight ratio of each asset.

According to the above technical solution, the present invention discloses and provides an asset allocation method and system, which fuses two frontiers into one frontier through the Sharpe ratio without facing abstract mathematical logic and complex calculation, can obtain the returns of the assets, the volatility and the Sharpe ratio only by data sorting, and can also obtain the optimal ratio of the assets.

The present invention maximizes the combined return level without increasing the risk of the combined variety, thereby greatly simplifying the invalid labor of the users.

At the same time, the asset allocation method provided by the present invention can well retain the returns of various combined varieties and smooth the volatility brought by each variety. The asset allocation method disclosed by the present invention is easy to understand, easy to operate, and capable of satisfying the huge market demands.

Other features and advantages of the present invention will be illustrated in the following description, and parts will become apparent from the description, or will be known through the implementation of the present invention. The purpose and other advantages of the present invention can be realized and obtained through the structures specially pointed out in the written description, claims and drawings.

The technical solution of the present invention is further described in detail below through the drawings and embodiments.

### DESCRIPTION OF DRAWINGS

To more clearly describe the technical solutions in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a flow chart of an asset allocation method in the present invention;

FIG. 2 is a schematic diagram of an efficient frontier constructed in the present invention.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The Sharpe ratio measures the excess returns of a portfolio, that is, the risk-free return rate obtained by investors for each risk they bear. Almost all media and professional investment institutions use the Sharpe ratio to evaluate funds and quantify investment, but do not know how to use the Sharpe ratio to construct and dynamically optimize the portfolios.

Because even the simplest portfolio optimization method in the textbook still requires a good mathematical understanding ability, it is often an insuperable barrier for many fund managers.

Thus, embodiments of the present invention disclose an asset allocation method and system, which can optimize the asset portfolios by calculating the return rate and the covariance matrix of stocks and using a Markowitz model and a Sharp ratio. In the optimization process, a method of random weight allocation is used for simulating calculation and comparison, and finally an asset portfolio with the optimal return/risk ratio is obtained.

In order to make those skilled in the art understand the implementation process of the solution of the present invention, the present invention is clearly explained below through embodiments.

### Embodiment 1

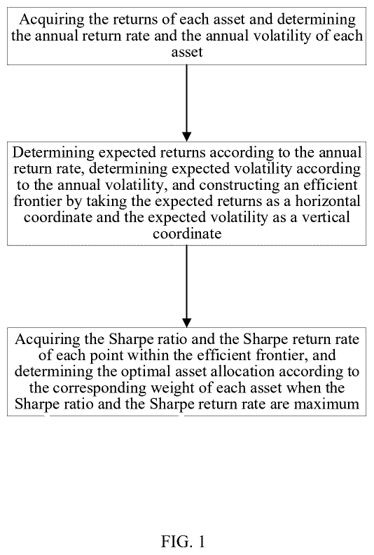

An asset allocation method comprises the following steps, as shown in FIG. 1:

Step 1, acquiring the returns of each asset and determining the annual return rate and the annual volatility of each asset.

In the present embodiment, the annual return rate is obtained by the following formula:

$${r}_{j} = {r}_{day} * 243$$

wherein rⱼ represents the return rate of the j^{th} asset; and r_{day} is the average return rate of the j^{th} asset, expressed as:

$${r}_{day} = 1 / n * {\sum }_{i = 1}^{n} {r}_{i}$$

wherein rᵢ is the return of the i^{th} period, and n represents the total number of periods.

The annual volatility is obtained by the following formula:

$${σ}_{j} = {σ}_{day} * 243$$

wherein σ_{day} is the average volatility of the j^{th} asset, and the expression is:

$${σ}_{d a y} = \sqrt{( 1 / n - 1 ) * {\sum }_{i = 1}^{n} ( {r}_{d a y} - \overline{{r}_{i}} )} .$$

r̅ᵢ represents the average return value of the previous i periods.

Wherein in one embodiment, the acquired returns of each asset are aligned and checked.

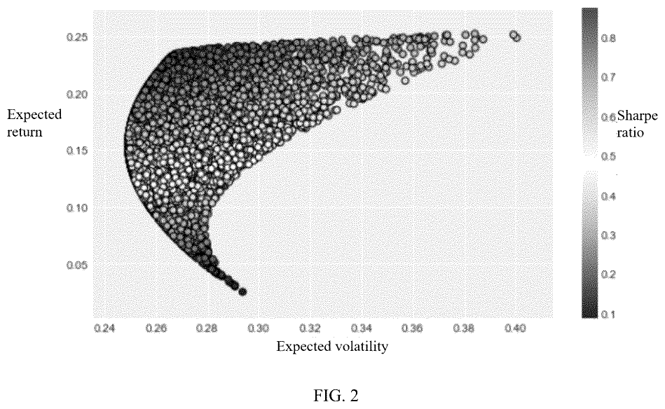

Step 2, determining expected returns according to the annual return rate, determining expected volatility according to the annual volatility, and constructing an efficient frontier by taking the expected returns as a horizontal coordinate and the expected volatility as a vertical coordinate, as shown in FIG. 2.

Wherein according to the annual return rate, the expected return is obtained by the following formula:

$$\begin{matrix}{r}_{p} = {\sum }_{j = 1}^{m} {ω}_{j} {r}_{j} , wherein {\sum }_{j = 1}^{m} {ω}_{j} = 1 \\ E ( {r}_{p} ) = {\sum }_{j = 1}^{m} {ω}_{j} E ( {r}_{j} )\end{matrix}$$

wherein ωⱼ is the weight of each asset and E(rₚ) is the expected return.

According to the annual volatility, the expected volatility is obtained by the following formula:

According to oₚ²=ΣΣωᵢωⱼCov(Rᵢ,Rⱼ)=ΣΣωᵢωⱼρᵢⱼσᵢσⱼ=WΣW^{T}, the following can be obtained:

$${σ}_{p} = \sqrt{W \sum {W}^{T}} , wherein \sum is$$

$$\sum = [ \begin{matrix}{σ}_{1}^{2} & {σ}_{12} & … & {σ}_{1 n} \\ {σ}_{21} & {σ}_{2}^{2} & … & {σ}_{2 n} \\ ⋮ & ⋮ & ⋱ & ⋮ \\ {σ}_{N 1} & {σ}_{N 2} & … & {σ}_{N}^{2}\end{matrix} ]$$

wherein W is a matrix of ωᵢ W^{T} is a transpose matrix, n is a sequence of securities, and N is nn, i.e., a matrix series of securities.

Step 3, acquiring the Sharpe ratio and the Sharpe return rate of each point within the efficient frontier, and determining the optimal asset allocation according to the weight of each required asset corresponding to the Sharpe ratio and the Sharpe return rate. At the same time, users can adjust the upper limit of allocation of each asset based on needs.

In the present invention, the Sharpe ratio is:

$$S = E ( {r}_{p} ) / {σ}_{p}$$

wherein E(rₚ) is the expected return, and σₚ is the expected volatility.

The expression of the Sharpe return rate is:

$${\overline{r}}_{p} = {\sum }_{i = 1}^{n} {ω}_{i} E ( {r}_{p} )$$

### Embodiment 2

An asset allocation system comprises:
a data processing module for determining the annual return rate and the annual volatility of each asset according to the returns of each asset;
a frontier constructing module for constructing an efficient frontier, comprising determining the horizontal coordinate of the efficient frontier according to the annual return rate and determining the vertical coordinate of the efficient frontier according to the annual volatility;
an asset allocation module for acquiring the Sharpe ratio and the Sharpe return rate of each point within the efficient frontier, and outputting the corresponding weight of each asset when the Sharpe ratio and the Sharpe return rate are maximum.

In the present embodiment, the asset allocation system further comprises a data preprocessing module for acquiring the returns of each asset, aligning, checking and then storing the returns for invocation by the data processing module; and
a display module for visually displaying the efficient frontier and the determined weight ratio of each asset by Matplotlib library.

The display module is also used for displaying the corresponding expected return rate, expected volatility and the corresponding Sharpe ratio of the determined weight ratio of each asset.

### Embodiment 3

The present embodiment provides the description of the application of the above allocation method or system, comprising:

Data selection;

Firstly, a portfolio is selected, which may comprise stocks, funds or bonds (for simple examples, the stocks are taken as an example). In the selection process, common indexes such as PE, PEG, etc. may be considered or any index such as sector hot spots and industry rotation can also be considered for selection.

The survey period is determined. The daily return data for the past year, the weekly return data for past three years or the monthly return data for past five years can be selected. If the selected time period is longer, a lower frequency can be selected to reduce the calculation. In the present embodiment, the time period matched with the investment strategy is preferred.

The data is aligned and checked. Due to the inconsistence of the period of time of stock listing, the data is aligned based on the minimum period.

The sorted data is stored. The asset allocation method or system of the present invention is operated to obtain a dot plot of a Markowitz efficient frontier. Generally, the portfolio with stable returns and volatility will present a neat graph; otherwise, there will be more discrete, rough edge and fat tail phenomena.

After the asset allocation of the present invention, two conclusions are finally outputted: comprising the return rate, the volatility and the Sharpe ratio of the proposed portfolio; and comprising recommended allocation weights of different stocks.

In the present embodiment, the upper limit of individual stock allocation can be further adjusted to sort the stocks with low allocation, and the varieties with low allocation can be replaced if necessary, so as to make the allocation of the portfolio more balanced and reduce the over-dependence on individual varieties.

After fully understanding the Markowitz efficient frontier theory, the present invention fuses the two frontier into one frontier through the Sharpe ratio, does not pursue the optimal allocation of all-market and all-variety resources, but maximizes the return level of the portfolio on the basis of the subjective cognition of fund managers without increasing the risk of the portfolio varieties, thereby greatly simplifying the ineffective labor of the user.

### Embodiment 4

As a portfolio optimization technology, the present invention can be used for assisting the management of individual pension assets, fund portfolios, insurance funds, bank funds, etc.

For the individual pension assets, long-term stable appreciation of pension assets should be pursued in the long run. However, in the youth stage of a person, pension funds are in the accumulation stage, and the pressure of cash expenditure is not high, so the person can withstand relatively high volatility risks and increase the allocation of stocks with higher risks. In the elderly stage, stable cash expenditure is needed. The allocation of high-dividend stocks and fixed-return assets shall be increased. In the first stage, the asset allocation method of the present invention can be used for constructing a stock portfolio for earning long-term high alpha based on index volatility. Such stocks may be technology stocks, brand consumer stocks, etc. that have core competitiveness. In the second stage, stable returns shall be taken as the goal to find a group of low-beta trustable stocks such as bank and insurance stocks, select the portfolio with the largest Sharpe ratio, and add a certain proportion of bonds and monetary funds to build an individual pension asset portfolio.

In the management of a fund portfolio, taking mutual funds of active management as an example, the main way to make profits is to rely on the subjective mining ability of the fund manager team, and the management goal, that is, the performance comparison benchmark is to beat an index for a long time. Therefore, the optimization technology of the present invention can play a good role. If the system can be added to the current information system, it is easy for the fund manager to select a portfolio reference that will maximize the Sharpe ratio of the portfolio from the familiar stocks by using a professional database. At present, in the domestic and foreign markets, the funds are evaluated generally by the level of the Sharpe ratio. There are rare pure subjective funds that can achieve a Sharpe ratio greater than 1 for a long time. Therefore, the quantitative optimization means of portfolios based on subjective stock selection should have the most extensive use prospects in public offering of fund.

Management of insurance assets. Similar to university endowment funds, insurance companies need to ensure that the return rate of assets is maintained at a certain level such as 5%-6% per year in order to pay insurance benefits to policyholders, which is equivalent to determining one of the efficient frontiers of the Markowitz model, that is, seeking the lowest-risk portfolio under certain returns. Therefore, the allocation optimization technology of the portfolio based on the Markowitz efficient frontier theory has a good use value for evaluating the management ability of the trustee for the client of the assets or for portfolio management of the fund manager at the trustee end of the insurance assets.

Firstly, as the main investor of the funds, the insurance companies can use this tool to select the fund portfolio efficiently and conveniently. Secondly, the insurance companies with teams that invest directly in stocks can also use the Markowitz model to construct a stock portfolio. Finally, in terms of major asset allocation, an index simulation mode can be used as a tool to make asset allocation decisions across asset classes. These assets may involve equity, bonds, real estate, etc. After indexation of these assets, Python technology can be used for optimizing the portfolio. The asset management sides of the insurance companies have strong technical teams, and are not difficult to index broad categories of assets.

In the asset management of banks, the system designed by the present invention maximizes the returns under certain risk conditions, and can be used as a means for portfolio managers to reduce risks in advance before construction of the portfolio and in the management process.

For using the system of the present invention, it is also necessary to fully understand the limitations of the modern portfolio theory. Meanwhile, it shall be understood that the conclusions of the system are made based on historical data at a certain stage, and the guiding significance for the future is also affected by time and environment and can only be used as a limited reference. Investors still need to consider other factors that may affect the market and individual stocks when making decisions according to the system.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. An asset allocation method, comprising:
acquiring the returns of each asset and determining the annual return rate and the annual volatility of each asset;
determining expected returns according to the annual return rate, determining expected volatility according to the annual volatility, and constructing an efficient frontier by taking the expected returns as a horizontal coordinate and the expected volatility as a vertical coordinate;
acquiring the Sharpe ratio and the Sharpe return rate of each point within the efficient frontier, and determining the optimal asset allocation according to the weight of each required asset corresponding to the Sharpe ratio and the Sharpe return rate.

2. The asset allocation method according to claim 1, wherein
the annual return rate is obtained by the following formula:
$${r}_{j} = {r}_{day} * 243$$
wherein rⱼ represents the return rate of the j^{th} asset; and r_{day} is the average return rate of the j^{th} asset, expressed as:
$${r}_{day} = 1 / n * {\sum }_{i = 1}^{n} {r}_{i}$$
wherein rᵢ is the return of the i^{th} period, and n represents the total number of periods; the annual volatility is obtained by the following formula:
$${σ}_{j} = {σ}_{day} * 243$$
wherein σ_{day} is the average volatility of the j^{th} asset, and the expression is:
$${σ}_{d a y} = \sqrt{( 1 / n - 1 ) * {\sum }_{i = 1}^{n} ( {r}_{d a y} - \overline{{r}_{i}} )} .$$
r̅ᵢ represents the average return value of the previous i periods.

3. The asset allocation method according to claim 2, wherein according to the annual return rate, the expected return is obtained by the following formula:
$$\begin{matrix}{r}_{p} = {\sum }_{j = 1}^{m} {ω}_{j} {r}_{j} , wherein {\sum }_{j = 1}^{m} {ω}_{j} = 1 \\ E ( {r}_{p} ) = {\sum }_{j = 1}^{m} {ω}_{j} E ( {r}_{j} )\end{matrix}$$
wherein ωⱼ is the weight of each asset and E(rₚ) is the expected return.

4. The asset allocation method according to claim 2, wherein according to the annual volatility, the expected volatility is obtained by the following formula:
$${σ}_{p} = \sqrt{W \sum {W}^{T}} , wherein \sum is$$
$$\sum = [ \begin{matrix}{σ}_{1}^{2} & {σ}_{12} & … & {σ}_{1 n} \\ {σ}_{21} & {σ}_{2}^{2} & … & {σ}_{2 n} \\ ⋮ & ⋮ & ⋱ & ⋮ \\ {σ}_{N 1} & {σ}_{N 2} & … & {σ}_{N}^{2}\end{matrix} ]$$
wherein W is a matrix of ωᵢ, W^{T} is a transpose matrix, n is a sequence of securities, and Nis nn, i.e., a matrix series of securities.

5. The asset allocation method according to claim 1, wherein the Sharpe ratio is:
$$S = E ( {r}_{p} ) / {σ}_{p}$$
wherein E(rₚ) is the expected return, and σₚ is the expected volatility;
the expression of the Sharpe return rate is:
$${\overline{r}}_{p} = {\sum }_{i = 1}^{n} {ω}_{i} E ( {r}_{p} )$$

6. The asset allocation method according to claim 1, wherein the acquired returns of each asset are aligned and checked.

7. An asset allocation system, comprising:
a data processing module for determining the annual return rate and the annual volatility of each asset according to the returns of each asset;
a frontier constructing module for constructing an efficient frontier, comprising determining the horizontal coordinate of the efficient frontier according to the annual return rate and determining the vertical coordinate of the efficient frontier according to the annual volatility;
an asset allocation module for acquiring the Sharpe ratio and the Sharpe return rate of each point within the efficient frontier, and outputting the corresponding weight of each asset when the Sharpe ratio and the Sharpe return rate are maximum.

8. The asset allocation system according to claim 7, further comprising a data preprocessing module for acquiring the returns of each asset, aligning, checking and then storing the returns for invocation by the data processing module.

9. The asset allocation system according to claim 7, further comprising a display module for visually displaying the efficient frontier and the determined weight ratio of each asset.

10. The asset allocation system according to claim 9, wherein the display module is also used for displaying the corresponding expected return rate, expected volatility and the corresponding Sharpe ratio of the determined weight ratio of each asset.
